(19) United States
(12) Patent Application Publication
(10) Pub. No.: US 2010/0287585 A1
(43) Pub. Date: Nov. 11, 2010

(54) SYSTEM AND APPARATUS FOR MEDIA SERVICE DELIVERY

(75) Inventors: MITCHELL ALLEN FRONDAL, Palatine, IL (US); Jason Savard, San Antonio, TX (US)

Correspondence Address: AT&T Legal Department - GMG;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/436,076

(22) Filed: May 5, 2009

(51) Int. Cl. H04N 7/167; H04N 7/173

(52) U.S. Cl. 725/31; 725/114

(57) ABSTRACT

A system that incorporates teachings of the present disclosure may include, for example, a system having a controller to receive from a portable communication device (PCD) identification information and a request for multicast media content supplied by an Internet Protocol Television (IPTV) network, detect that the PCD is authorized to receive the requested media content according to the identification information, transmit to the PCD one or more decryption keys responsive to said detection, determine from the identification information a media presentation format used by the PCD, instruct an acquisition server (A-server) of the IPTV network to transcode the requested media content according to the media presentation format upon receiving the requested media content on a multicast channel, receive from the A-server the transcoded media content, encrypt the transcoded media content, and transmit the encrypted and transcoded media content to the PCD over a unicast channel. Other embodiments are disclosed.

### FIELD OF THE DISCLOSURE

The present disclosure relates generally to media services and more specifically to a system and apparatus for media service delivery.

### BACKGROUND

Portable communication devices such as cellular phones and laptop computers can receive media content from for example Internet media content portals such as YouTube.com, iTunes.com or other media delivery services. Typically, media delivery services supply media content as streaming content or as downloadable files which are subsequently played back by the portable communication device. Digital rights management instructions can be transmitted with the streamed or downloadable content to protect against misappropriation of the content.

### BRIEF DESCRIPTION OF THE DRAWINGS

FIGS. 1-2 depict illustrative embodiments of communication systems that provide media services;

FIG. 3 depicts an illustrative embodiment of a portal interacting with the communication systems of FIGS. 1-2;

FIG. 4 depicts an illustrative embodiment of a communication device utilized in the communication systems of FIGS. 1-2;

FIG. 5 depicts an illustrative embodiment of a method operating in portions of the communication systems of FIGS. 1-2;

FIG. 6 depicts an illustrative embodiment of a communication system operating according to the method of FIG. 5; and

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail a system having a controller to receive from a portable communication device (PCD) identification information and a request for multicast media content supplied by an Internet Protocol Television (IPTV) network, detect that the PCD is authorized to receive the requested media content according to the identification information, transmit to the PCD one or more decryption keys responsive to said detection, determine from the identification information a media presentation format used by the PCD, instruct an acquisition server (A-server) of the IPTV network to transcode the requested media content according to the media presentation format upon receiving the requested media content on a multicast channel, receive from the A-server the transcoded media content, encrypt the transcoded media content, thereby generating encrypted and transcoded content, and transmit the encrypted and transcoded media content to the PCD over a unicast channel.

One embodiment of the present disclosure can entail a computer-readable storage medium operating in a first network element of an iTV network having computer instructions to receive from a communication device identification information and a request for multicast media content supplied by the iTV network, wherein the communication device communicates with the first network element by way of a communication system operating independently of the iTV network, transmit to the communication device one or more decryption keys, determine from the identification information a media presentation format used by the communication device, instruct a second network element of the iTV network to transcode the requested media content according to the media presentation format upon receiving the requested media content on a multicast channel, receive from the second network element of the iTV network the transcoded media content, encrypt the transcoded media content, thereby generating encrypted and transcoded content, and transmit the encrypted and transcoded media content to the communication device over a unicast channel.

One embodiment of the present disclosure can entail a communication device having a controller to transmit to a first network element of an iTV network identification information and a request for multicast media content supplied by iTV network to set-top boxes operating in a plurality of premises, receive from the first network element the one or more decryption keys, receive from the first network element over a unicast channel the encrypted and transcoded media content, decrypt the encrypted and transcoded media content according to the one or more decryption keys received from the first network element, and present the decrypted content on a presentation device. The first network element can be operable to instruct a second network element to authenticate that the communication device is authorized to receive the requested media content according to the identification information, transmit to the communication device one or more decryption keys responsive to the authentication, determine from the identification information a media presentation format used by the communication device, instruct a third network element of the iTV network to transcode the requested media content according to the media presentation format upon receiving the requested media content on a multicast channel, receive from the third network element the transcoded media content, encrypt the transcoded media content, thereby generating encrypted and transcoded content, and transmit the encrypted and transcoded content to the communication device.

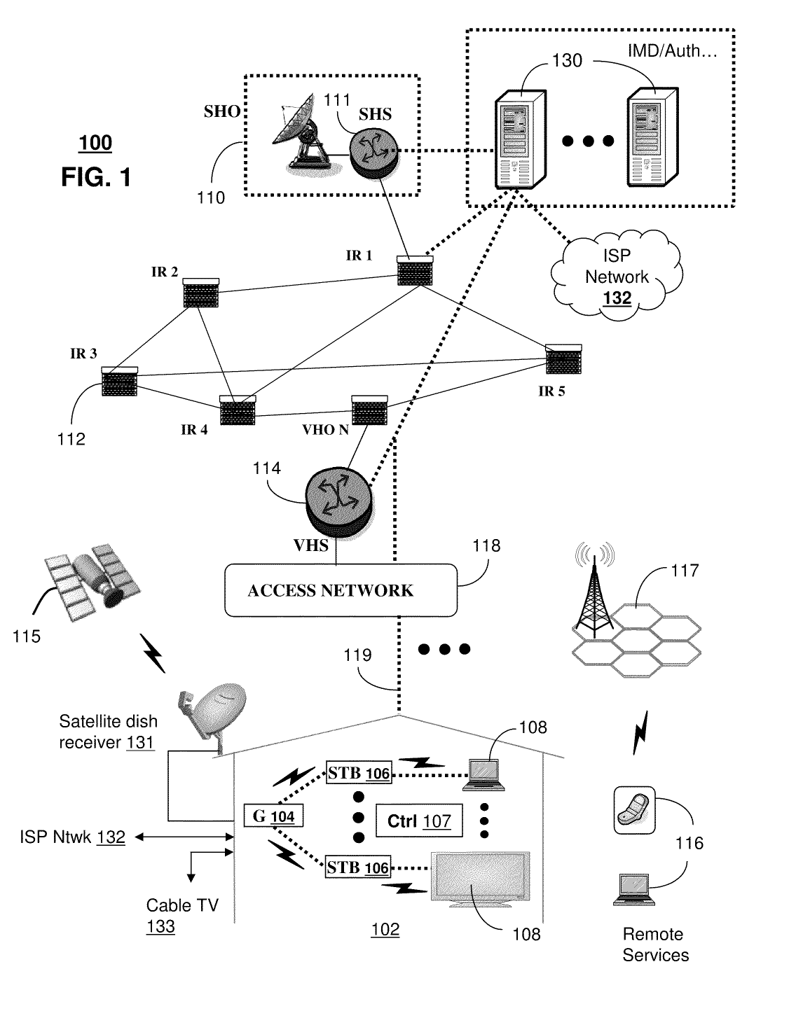

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to a video head-end server (VHS) 114 of a video hub offices (VHO) 112 over a network of IP routers (IRs) according to a common multicast communication protocol.

The VHS 114 can distribute multimedia broadcast programs via an access network 118 to commercial and/or residential buildings 102 housing a gateway 104 (such as a common residential or commercial gateway). The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

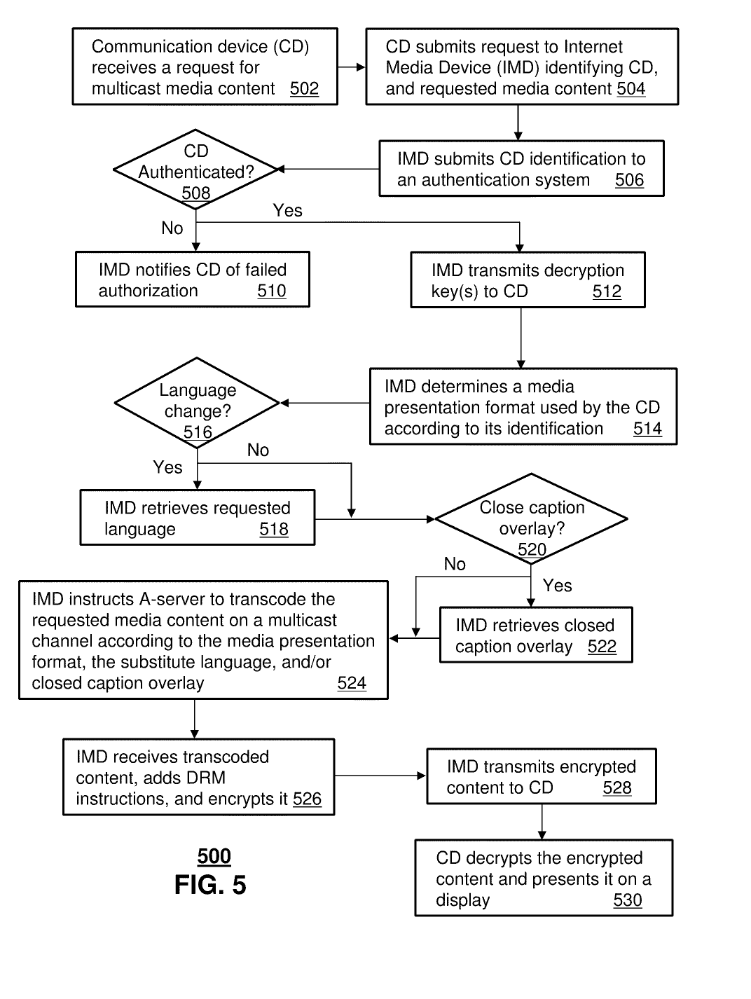

Another distinct portion of the computing devices 130 can function as an Internet Media Device and Authentication System (herein referred to as IMD 130). The IMD 130 can use common computing and communication technology to manage unicast requests from portable devices such as the cellular phone 116 and/or portable personal computer 116 of FIG. 1. The IMD 130 will be discussed further in FIG. 5.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services.

It follows from the above illustrations that the present disclosure can apply to any present or future interactive over-the-air or landline media content services.

FIG. 2 depicts an illustrative embodiment of a communication system 200 employing an IP Multimedia Subsystem (IMS) network architecture to facilitate the combined services of circuit-switched and packet-switched systems. Communication system 200 can be overlaid or operably coupled with communication system 100 as another representative embodiment of communication system 100.

Communication system 200 can comprise a Home Subscriber Server (HSS) 240, a tElephone NUmber Mapping (ENUM) server 230, and other common network elements of an IMS network 250. The IMS network 250 can establish communications between IMS compliant communication devices (CD) 201, 202, Public Switched Telephone Network (PSTN) CDs 203, 205, and combinations thereof by way of a Media Gateway Control Function (MGCF) 220 coupled to a PSTN network 260. The MGCF 220 is not used when a communication session involves IMS CD to IMS CD communications. Any communication session involving at least one PSTN CD requires the use of the MGCF 220.

IMS CDs 201, 202 can register with the IMS network 250 by contacting a Proxy Call Session Control Function (P-CSCF) which communicates with a corresponding Serving CSCF (S-CSCF) to register the CDs with at the HSS 240. To initiate a communication session between CDs, an originating IMS CD 201 can submit a Session Initiation Protocol (SIP INVITE) message to an originating P-CSCF 204 which communicates with a corresponding originating S-CSCF 206. The originating S-CSCF 206 can submit queries to the ENUM system 230 to translate an E.164 telephone number in the SIP INVITE to a SIP Uniform Resource Identifier (URI) if the terminating communication device is IMS compliant.

The SIP URI can be used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214. The terminating S-CSCF 214 can then identify a terminating P-CSCF 216 associated with the terminating CD 202. The P-CSCF 216 then signals the CD 202 to establish communications.

If the terminating communication device is instead a PSTN CD such as references 203 or 205, the ENUM system 230 can respond with an unsuccessful address resolution which can cause the originating S-CSCF 206 to forward the call to the MGCF 220 via a Breakout Gateway Control Function (BGCF) 219. The MGCF 220 can then initiate the call to the terminating PSTN CD by common means over the PSTN network 260.

The aforementioned communication process is symmetrical. Accordingly, the terms “originating” and “terminating” in FIG. 2 are interchangeable. It is further noted that communication system 200 can be adapted to support video conferencing. In addition, communication system 200 can be adapted to provide the IMS CDs 201, 203 the multimedia and Internet services of communication system 100.

The IMD 130 of FIG. 1 can be operably coupled to the second communication system 200 for purposes similar to those described above.

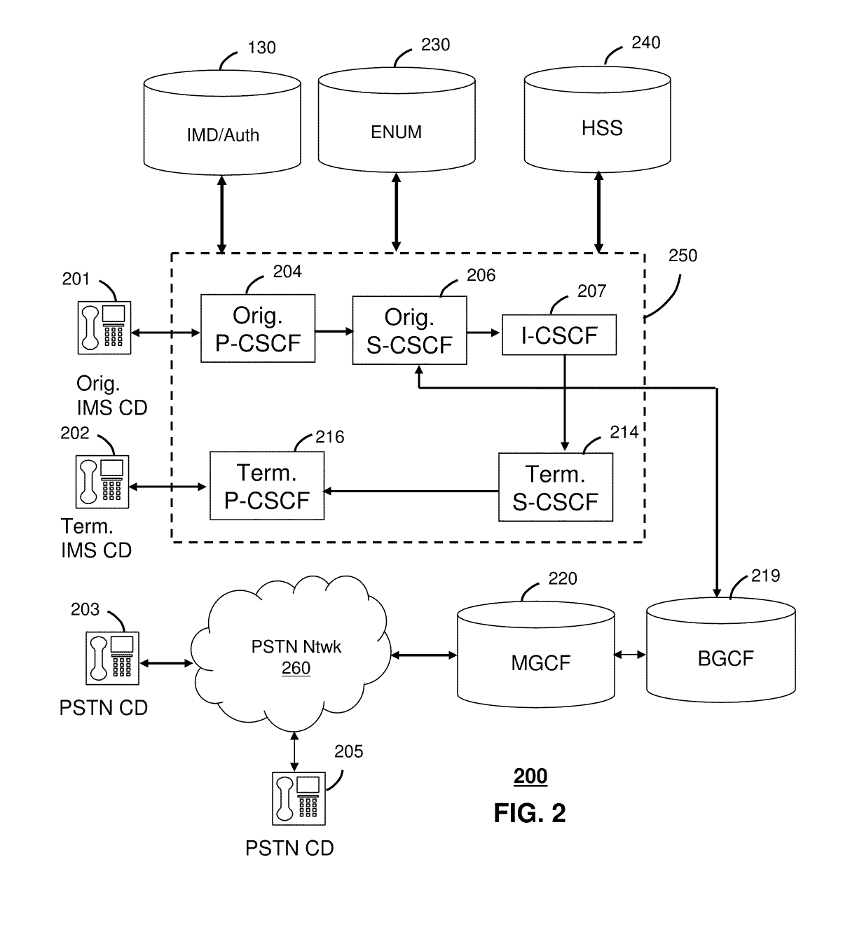

FIG. 3 depicts an illustrative embodiment of a portal 302 which can operate from the computing devices 130 described earlier of communication 100 illustrated in FIG. 1. The portal 302 can be used for managing services of communication systems 100-200. The portal 302 can be accessed by a Uniform Resource Locator (URL) with a common Internet browser such as Microsoft's Internet Explorer™ using an Internet-capable communication device such as those described for FIGS. 1-2. The portal 302 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services described earlier, provisioning Internet services, provisioning cellular phone services, and so on.

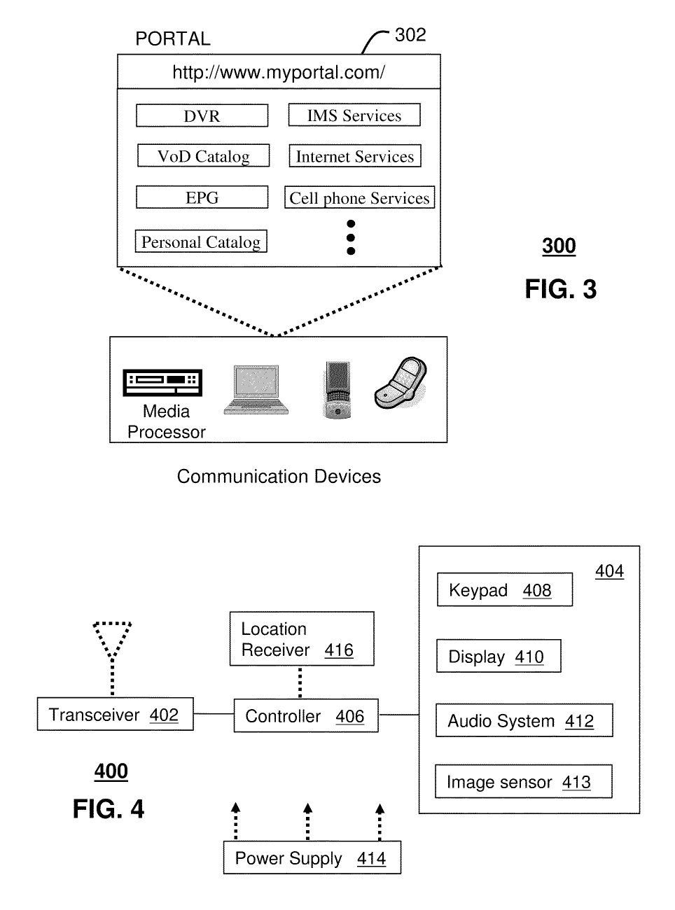

FIG. 4 depicts an exemplary embodiment of a communication device 400. Communication device 400 can serve in whole or in part as an illustrative embodiment of the communication devices of FIGS. 1-2. The communication device 400 can comprise a wireline and/or wireless transceiver 402 (herein transceiver 402), a user interface (UI) 404, a power supply 414, a location receiver 416, and a controller 406 for managing operations thereof. The transceiver 402 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 404 can include a depressible or touch-sensitive keypad 408 with a navigation mechanism such as a roller ball, joystick, mouse, or navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric dialing keypad commonly used by phones, and/or a Qwerty keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display.

The UI 404 can also include an audio system 412 that utilizes common audio technology for conveying low volume audio (such as audio heard only in the proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and charging system technologies for supplying energy to the components of the communication device 400 to facilitate long-range or short-range portable applications. The location receiver 416 can utilize common location technology such as a global positioning system (GPS) receiver for identifying a location of the communication device 400 based on signals generated by a constellation of GPS satellites, thereby facilitating common location services such as navigation.

The communication device 400 can use the transceiver 402 to also determine a proximity to a cellular, WiFi or Bluetooth access point by common power sensing techniques such as utilizing a received signal strength indicator (RSSI) and/or a signal time of arrival (TOA) or time of flight (TOF). The controller 406 can utilize computing technologies such as a microprocessor, a digital signal processor (DSP), and/or a video processor with associated storage memory such a Flash, ROM, RAM, SRAM, DRAM or other storage technologies.

The communication device 400 can be adapted to perform the functions of the media processor 106, the media devices 108, or the portable communication devices 116 of FIG. 1, as well as the IMS CDs 201-202 and PSTN CDs 203-205 of FIG. 2. It will be appreciated that the communication device 400 can also represent other common devices that can operate in communication systems 100-200 of FIGS. 1-2 such as a gaming console and a media player.

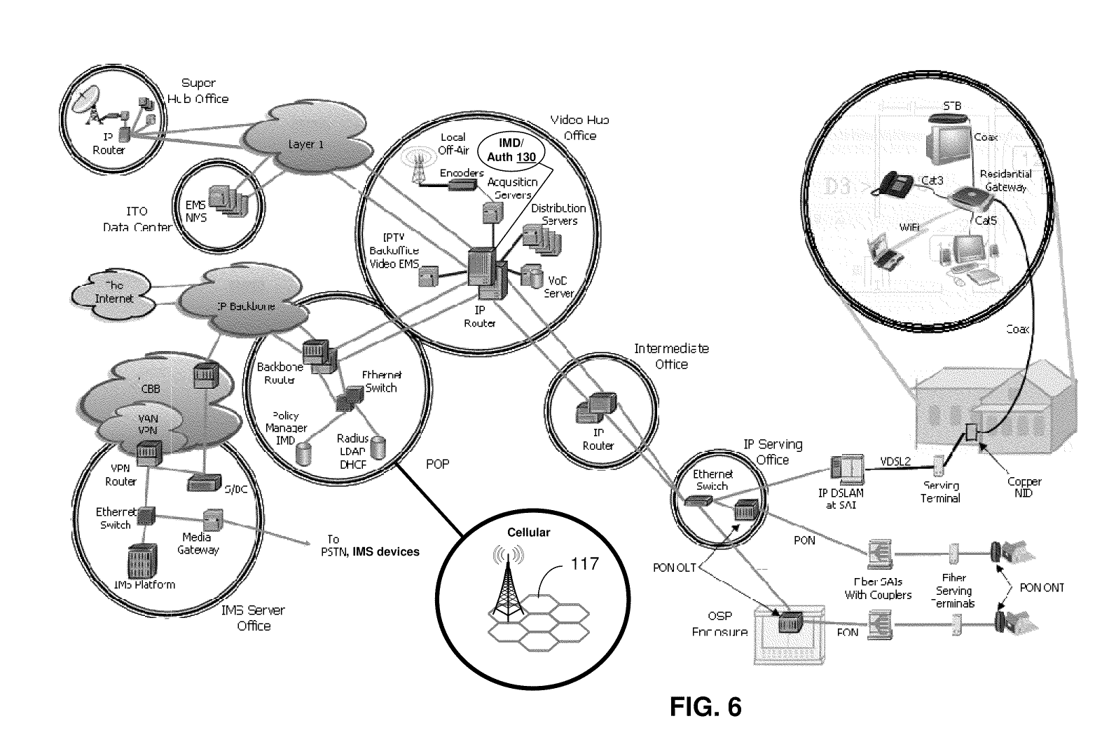

FIG. 5 depicts an illustrative method 500 that operates in portions of the communication systems of FIGS. 1 and 2. FIG. 6 depicts an illustrative embodiment that combines the communication systems of FIGS. 1 and 2. The illustrations of FIG. 6 serve as an aid in describing method 500. Method 500 can begin with step 502 in which a communication device such as the cellular phone 116 of FIG. 1 receives a request from its user to present multicast media content that is intended for delivery to an STB 106. The cellular phone 116 can be communicatively coupled to the base station 117 of FIG. 6, which in turn can be couple to an ISP network which is coupled to an interactive TV (iTV) network (such as an IPTV network previously described) for delivering multicast content to STBs in residences such as shown in FIG. 6.

The user of the cellular phone 116 can for example browse an EPG supplied by the iTV network over an Internet communication session by way of the user's portal 302. The user can select the requested multicast media content from the EPG presentation. Once selected, the cellular phone 116 can transmit the request to the IMD 130 at step 504 over another Internet communication session with the VHO from which the IMD 130 operates. The request can include an identification of the cellular phone (e.g., caller ID, personal identification number, SIP URI, static IP address, subscriber account information, login, password, a MAC address, an ESN, an IMEI, and so on).

The request the also identify the requested multicast media content by name, metadata identification, or some other form of identification retrieved from the EPG. In step 506, the IMD 130 can submit the identification of the cellular phone 116 to an authentication system. The authentication system can be an integral part of the IMD 130 or an independently operated system. The authentication system can utilize a common authentication, authorization, and accounting (AAA) protocol to perform the authentication process using the identification information supplied by the cellular phone 116. The authentication system can also operate as a common remote authentication dial in user service (RADIUS) operating according to the AAA protocol.

If the authentication system determines that the cellular phone 116 is a subscriber, and is authorized to receive the requested content, the IMD 130 can proceed to step 512. Otherwise, the IMD 130 notifies the cellular phone in step 510 that authorization for the requested content failed. In step 512, the IMD 130 can generate one or more decryption keys which are transmitted to the cellular phone 116 to decrypt the content to be transmitted to the cellular phone 116. In step 514, the IMD 130 can determine a media presentation format used by the cellular phone 116 according to its identification. In this step, the IMD 130 can for example retrieve from a database indexed by subscriber information provided in the request operational characteristics that describe the resources of the cellular phone 116 (e.g., display type, display size, display resolution, aspect ratio, CPU type, CPU resources for video and/or audio processing, etc.). The media presentation format can also describe characteristics of the communication medium (e.g., Quality of Service available, bandwidth of communication over the data channel supplied by the base station, etc.)

The request supplied by the cellular phone 116 can also identify a request for a language that differs from a default language supplied with the media content. For example, the user may desire that audio portion of a TV show or movie be presented in Spanish as opposed to a standard English presentation. Language options can be presented at the cellular phone 116 from metadata provided with the EPG. If a language change is detected in step 516, the IMD 130 can proceed to step 518 where the IMD 130 or another network element (such as an Acquisition server or A-server of the VHO—see FIG. 6) retrieves the requested language from the multicast stream of the requested media content or a database at the VHO or some other source available to the VHO (e.g., a database of the content provider supplying the requested media content).

In step 520, the IMD 130 can also determine whether the request submitted by the user of the cellular phone 116 requires a closed caption overlay of text describing what is being said in the media content. Closed caption text on a video screen can be useful to someone who has a hearing impairment, or for someone located in an area where there is substantial ambient noise and captioned text can be a supplement or when the user intends to mute audio to avoid disturbing others. The closed caption option can also be retrieved from metadata supplied by the EPG. If a closed caption selection is detected in step 520, the IMD 130 or another network element of the iTV network directed by the IMD can retrieve the closed caption overlay in step 522 from the multicast stream or from a local or remote database as previously described for step 518.

In step 524, the IMD 130 can instruct a common A-server such as shown in the VHO of FIG. 6 to intercept the requested media content on a multicast stream, and transcode the requested content according to the media presentation format of the cellular phone 116. For example the A-server can be instructed to reformat media content in the form of a video stream from a 780p format having a 16:9 aspect ratio, to a picture-in-picture image sized format that satisfies the format and resolution capabilities of the cellular phone 116. The A-server can also be directed to transcode the requested multicast content to a portrait or landscape presentation for viewing on the cellular phone 116. The audio portion of the multicast content can also be downgraded to a format which balances video and audio quality. The A-server can also transcode the media content so that the collective video and audio content does not exceed the channel bandwidth limitations of the over-the-air data channel provided by the base station 117 (e.g., GPRS, EV DO or some other data channel technology).

Once the media content is transcoded, the IMD 130 can in step 526 combine the transcoded content with digital rights management (DRM) instructions. The DRM instructions can direct the cellular phone 116 not to store a local copy of the streamed content or redirect the streamed content to other devices communicatively coupled to the cellular phone 116 (such as by way of a Bluetooth, WiFi, or other network connection). In step 526, the IMD 130 can encrypt the transcoded content with its corresponding DRM instructions. The encrypted content can then be transmitted by the IMD 130 to the cellular phone 116 as streamed content over a secure encrypted unicast channel established between the IMD 130 and the cellular phone 116. The cellular phone 116 can decrypt in step 530 the encrypted content using the one or more decryption keys supplied in step 512 while it is being streamed by the IMD 130. The decrypted content can then be presented on a display of the cellular phone 116 for consumption by the user.

Upon reviewing the aforementioned embodiments, it would be evident to an artisan with ordinary skill in the art that said embodiments can be modified, reduced, or enhanced without departing from the scope and spirit of the claims described below. For example, step 524 can be adapted so that the IMD 130 directs a common distribution server (D-server) to perform the transcoding step discussed above. In another embodiment, the function of the IMD 130 can include the A-server or D-server functions or a transcoder that can perform the function described method 500. In yet another embodiment, the authentication system or RADIUS can be an independently operated system operating remotely from the VHO of FIG. 6. In another embodiment, the media content requested can represent audio only content such as music. This content can be presented on a display with a background setting while the music is playing, or with closed caption text that presents music lyrics. In another embodiment, the communication device requesting the multicast media content can represent a VoIP-enabled device in the IMS network of FIG. 2, which is capable of requesting and consuming media content as described in FIG. 5.

Other suitable modifications can be applied to the present disclosure without departing from the scope of the claims below. Accordingly, the reader is directed to the claims section for a fuller understanding of the breadth and scope of the present disclosure.

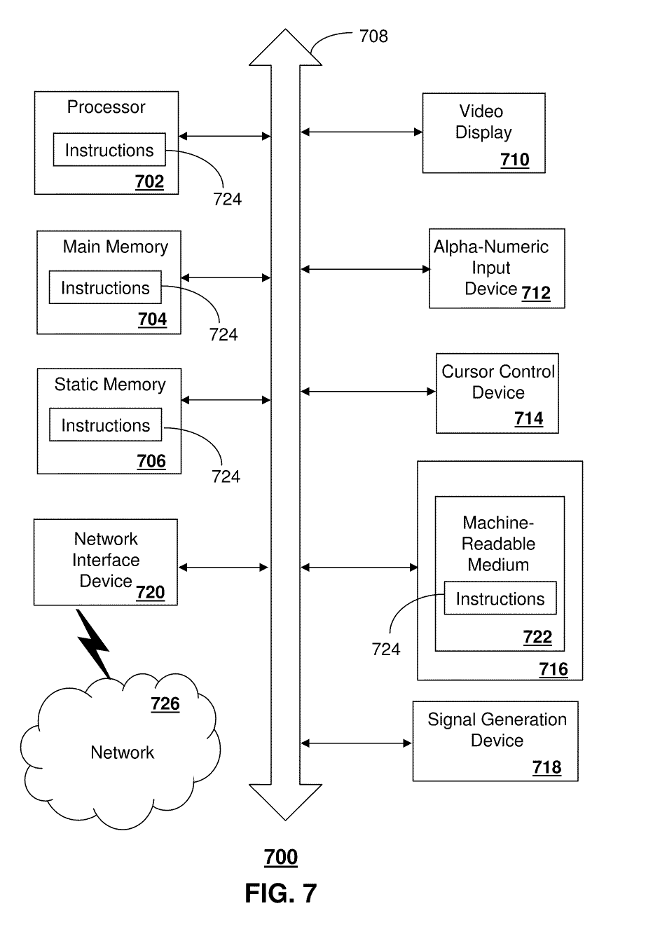

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system, comprising a controller to:
receive from a portable communication device (PCD) identification information and a request for multicast media content supplied by an Internet Protocol Television (IPTV) network;
detect that the PCD is authorized to receive the requested media content according to the identification information;
transmit to the PCD one or more decryption keys responsive to said detection;
determine from the identification information a media presentation format used by the PCD;
instruct an acquisition server (A-server) of the IPTV network to transcode the requested media content according to the media presentation format upon receiving the requested media content on a multicast channel;
receive from the A-server the transcoded media content;
encrypt the transcoded media content, thereby generating encrypted and transcoded content; and
transmit the encrypted and transcoded media content to the PCD over a unicast channel.

2. The system of claim 1, wherein the controller is operable to:
instruct the A-server to transcode the requested media content received on the multicast channel to a picture-in-picture sized imaging format that conforms with the media presentation format used by the PCD; and
combine digital rights management instructions with the transcoded media content prior to the encryption step.

3. The system of claim 1, wherein the PCD utilizes the one or more decryption keys to decrypt the encrypted and transcoded media content.

4. The system of claim 1, wherein the media presentation format comprises audio format and an imaging format, and wherein the request received from the PCD identifies a selection of an audible language differing from a default audible language used for presenting the requested media content, and wherein the controller is operable to instruct the A-server to:
retrieve the requested audible language;
replace the default audible language of the received multicast media content with the retrieved audible language, thereby generating updated media content; and
transcode the updated media content so that said media content conforms to the imaging and audio formats of the PCD.

5. The system of claim 1, wherein the request received from the PCD identifies a selection of a closed caption overlay, and wherein the controller is operable to instruct the A-server to:
retrieve the closed caption overlay associated with the requested media content;
combine the retrieved closed caption overlay with the requested media content, thereby generating updated media content; and
transcode the updated media content according to the media presentation format.

6. The system of claim 1, wherein the system operates in a video hub office.

7. The system of claim 1, wherein the system comprises an Internet media device (IMD) and an authentication system, wherein the IMD performs the encryption step and delivers the one or more decryption keys to the PCD.

8. The system of claim 7, wherein the authentication system operates according to an authentication, authorization, and accounting (AAA) protocol.

9. The system of claim 8, wherein the authentication system corresponds to a remote authentication dial in user service (RADIUS) operating according to the AAA protocol.

10. The system of claim 1, wherein the PCD comprises one of a cellular phone, and a computer.

11. The system of claim 1, wherein the requested media content comprises one of audio content, video content, and combinations thereof.

12. A computer-readable storage medium operating in a first network element of an interactive television (iTV) network, comprising computer instructions to:
receive from a communication device identification information and a request for multicast media content supplied by the iTV network, wherein the communication device communicates with the first network element by way of a communication system operating independently of the iTV network;
transmit to the communication device one or more decryption keys;
determine from the identification information a media presentation format used by the communication device;
instruct a second network element of the iTV network to transcode the requested media content according to the media presentation format upon receiving the requested media content on a multicast channel;
receive from the second network element of the iTV network the transcoded media content;
encrypt the transcoded media content, thereby generating encrypted and transcoded content; and
transmit the encrypted and transcoded media content to the communication device over a unicast channel.

13. The storage medium of claim 12, comprising computer instructions to:
transmit the identification information of the communication device to a third network element to authenticate that the communication device is authorized to receive the requested media content according to the identification information; and
receive notification from the third network element that the communication device has been authenticated.

14. The storage medium of claim 13, comprising computer instructions to generate the one or more decryption keys responsive to the notification.

15. The storage medium of claim 12, comprising computer instructions to instruct the second network element to transcode the requested media content received on the multicast channel to a picture-in-picture sized imaging format that conforms with the media presentation format used by the communication device.

16. The storage medium of claim 12, wherein the PCD utilizes the one or more decryption keys to decrypt the encrypted and transcoded media content.

17. The storage medium of claim 12, wherein the media presentation format comprises audio format and an imaging format, and wherein the request received from the communication device identifies a selection of an audible language differing from a default audible language used for presenting the requested media content, and wherein the storage medium comprises computer instructions to instruct the second network element to:
retrieve the requested audible language;
replace the default audible language of the received multicast media content with the retrieved audible language, thereby generating updated media content; and
transcode the updated media content so that said media content conforms to the imaging and audio formats of the communication device.

18. The storage medium of claim 12, wherein the request received from the communication device identifies a selection of a closed caption overlay, and wherein the storage medium comprises computer instructions to instruct the second network element to:
retrieve the closed caption overlay associated with the requested media content;
combine the retrieved closed caption overlay with the requested media content, thereby generating updated media content; and
transcode the updated media content according to the media presentation format.

19. The storage medium of claim 12, wherein the first element comprises an Internet media device, wherein the second network element comprises at least one of a transcoder, an acquisition server, and a distribution server, wherein the third network element comprises an authentication system, and wherein the communication system corresponds to one of a cellular communication system, and an Internet Service Provider.

20. The storage medium of claim 19, wherein the authentication system operates according to an authentication, authorization and accounting (AAA) protocol, and wherein the authentication system corresponds to a remote authentication dial in user service (RADIUS) operating according to the AAA protocol.

21. The storage medium of claim 12, wherein the communication device comprises one of a cellular phone, and a computer, wherein the requested media content comprises one of audio content, video content, and combinations thereof, and wherein the iTV network comprises one of an Internet Protocol TV (IPTV) network, an interactive cable TV network, and an interactive satellite TV network.

22. The storage medium of claim 12, wherein the identification information of the communication device comprises at least one of a personal identification number, a login name, a password, a subscriber account identifier, a uniform resource identifier, a session initiation protocol (SIP) URI, and an e.164 identifier.

23. A communication device, comprising a controller to:
transmit to a first network element of an interactive television (iTV) network identification information and a request for multicast media content supplied by iTV network to set-top boxes operating in a plurality of premises, wherein the first network element is operable to:
instruct a second network element to authenticate that the communication device is authorized to receive the requested media content according to the identification information;
transmit to the communication device one or more decryption keys responsive to the authentication;
determine from the identification information a media presentation format used by the communication device;
instruct a third network element of the iTV network to transcode the requested media content according to the media presentation format upon receiving the requested media content on a multicast channel;
receive from the third network element the transcoded media content;
encrypt the transcoded media content, thereby generating encrypted and transcoded content; and
transmit over a unicast channel the encrypted and transcoded content to the communication device;
receive from the first network element the one or more decryption keys;
receive from the first network element over the unicast channel the encrypted and transcoded media content;
decrypt the encrypted and transcoded media content according to the one or more decryption keys received from the first network element; and
present the decrypted content on a presentation device.

24. The communication device of claim 23, wherein the communication device comprises one of a cellular phone and a portable computer, wherein the iTV network comprises one of an Internet Protocol TV (IPTV) network, an interactive cable TV network, and an interactive satellite TV network, wherein the first element comprises an Internet media device, wherein the second network element comprises at least one of an encoder, an acquisition server, and a distribution server, and wherein the third network element comprises an authentication system.

25. The communication device of claim 23, wherein the request comprises one of a request for a closed caption overlay and an audible language differing from a default audible language used for presenting the requested media content, and wherein the received encrypted and transcoded media content comprises at least one of the requested closed caption overlay and the requested audible language.
